(19) United States
(12) Patent Application Publication
(10) Pub. No.: US 2016/0035458 A1
(43) Pub. Date: Feb. 4, 2016

(54) THE METHOD OF PRODUCING SELF-ROLLING ELONGATE ELEMENT, IN PARTICULAR AN ELECTRIC CABLE AND SELF-ROLLING ELONGATE ELEMENT, IN PARTICULAR AN ELECTRIC CABLE

(71) Applicant: Rafal JUSZKO, Chroscina (PL)

(72) Inventors: Rafal JUSZKO, Chróscina (PL); Wojciech WODO, Belchatów (PL)

(73) Assignee: Rafal JUSZKO, Chroscina (PL)

(21) Appl. No.: 14/783,437

(22) PCT Filed: Apr. 16, 2014
(86) PCT No.: PCT/PL2014/000039

§ 371 Date: Oct. 9, 2015

(30) Foreign Application Priority Data
Apr. 22, 2013 (PL) P.403630

(51) Int. Cl. H01B 7/02; H01B 13/06

(52) U.S. Cl. CPC H01B 7/0275; H01B 13/06

(57) ABSTRACT

The subject of the invention is the method of producing self-rolling elongate element, in particular an electric cable and self-rolling elongate element, in particular an electric cable intended especially for power and signal transmission wires, ropes and cords. The essence of the method, according to the invention, consists in applying to the power transmission wires, the outer coating (1) of a polymer composite, consisting of a polymer and a material, which has magnetic properties in the amount of from 10% to 60% by weight and subsequently, the power transmission wire (2) with the applied outer layer (1) is being magnetized in the magnetic field, which lines are situated along the axis of element rolling, wherein the magnetic induction is equal to at least 2 Tesla. The element has the outer layer (1) contacting directly with the environment of the cable is made of polymer composite, consisting of a polymer and a material, which has magnetic properties in the amount of from 10% to 60% by weight, wherein the outer coating is magnetized along the axis of the element rolling.

The subject of the invention is the method of producing self-rolling elongate element, in particular an electric cable and self-rolling elongate element, in particular an electric cable intended especially for power and signal transmission wires, ropes and cords.

The composition for covering the cables and electric cable are known from the Polish patens specification No. 185886. The composition is multimodal mixture of olefin polymers with the density of approximately 0.915-0.955 g/cm3 and the flow rate in the alloy of approximately 0.1-0.3 g/10 min., wherein the aforementioned mixture of olefin polymers consists of at least the first and the second olefin polymer, of which the first has the selected density and flow rate in the alloy of approximately 0.930-0.975 g/cm3 and approximately 50-2000 g/10 min., and 0.88-0.93 g/cm3 and approximately 0.1-0.8 g/10 min. The mixture of olefin polymers has been produced in the process of coordination catalyzed polymerization of at least one Ó-olefin extending in several stages, with the recommendation that there were two stages, including the return reactor and reactor for polymerization in the gas-phase or reactor for polymerization in the gas-phase and the second one for polymerization in the gas-phase, by polymerization or ethylene copolymerization in the first stage and copolymerization of ethylene with butane, 4-methylo-1penthen, 1-hexene or 1-octene in the second stage.

The electric cable known from the Polish patent application No. 384776 has a polymer thermoplastic cable coating consisting of component layers, each of which consists of transition zones, wherein the layers and zones of the coating have different, clearly defined structure and this is the reason why they have different properties and characteristics. The outer layer of the coating, contacting directly with the environment of the cable has a macroscopic thickness and is solid, the middle layer of the coating of a macroscopic thickness is microporous, and the inner layer of the coating, adhesively adhered to the surface of the metal current conductor has the macroscopic thickness and is solid. There are two transition zones: the first one is located between the outer and the middle layer and the second is located between the middle and the inner layer.

Thermoplastic multi-zone coating known from the Polish patent specification No. 210229 is porous and mono-polymeric. The coating obtained in the process of extrusion coating, adhesively adheres to the surface of construction material, especially to the outer surface of cable cores. The coating comprises of a core zone, two intermediate zones and two subsurface zones, wherein the core zone is located in the central region of the coating, while the two intermediate zones are adjacent to both sides thereof; and on the other side to the surface of the construction material, especially to the outer surface of cable cores, while the second subsurface zone is adjacent on one side to the intermediate zone, and on the other side it is in a direct contact with the surrounding environment of the cable.

The essence of the method, according to the invention, consists in applying to the power transmission wires, the outer coating of a polymer composite, consisting of a polymer and a material, which has magnetic properties in the amount of from 10% to 60% by weight. Subsequently power transmission wire with applied outer coating are magnetized in a magnetic field acting along the axis of the element rolling, which magnetic induction equals to at least 2 Tesla.

Preferably, to the power transmission wire made of a wire of a circular cross section, the outer layer of thickness equal to at least its diameter is applied.

Preferably, the outer layer is applied to the power transmission wire in the magnetic field.

Preferably, the outer layer is applied directly to the metal power transmission wire.

Preferably, the outer layer is applied from the polymer composite consisting of polyvinylchloride.

Preferably, the outer layer is applied from the polymer composite consisting of ferrite.

Preferably, the outer layer is applied from the polymer composite consisting of neodymium.

The essence of the method, according to the invention, consists in that the outer layer contacting directly with the environment of the cable is made of polymer composite, consisting of a polymer and a material, which has magnetic properties in the amount of from 10% to 60% by weight, wherein the outer coating is magnetized along the axis of the element rolling.

Preferably, the outer layer is applied directly to the metal power transmission wire.

Preferably, the polymer is polyvinylchloride.

Preferably, the material of magnetic properties is ferrite or neodymium.

Preferably, to the power transmission wire made of a wire of a circular cross section, the outer layer of thickness equal to at least its diameter is applied.

Preferably, the material of magnetic properties is comminuted, or made in the form of tapes placed on the polymer layer or in polymer layer, or made in the form of bars placed on the polymer layer or embedded in the polymer layer, or made from permanent magnets.

The method of production of self-rolling elongate element, according to the invention, is based on providing the elongate elements with magnetic properties by adding to them magnetic elements and their magnetization. Direction of magnetizing of the self-rolling elongate element proceeds along its axis of rolling, and due to the magnetization the element can be easily rolled into regular loops with the diameter dependent on its thickness and flexibility. The additional feature of the element is providing it with the properties of protective filter against electromagnetic field. In case of two or more similarly magnetized elements they show a tendency to roll into one larger element, due to which they do not require additional joining to keep them in one bundle. The outer layer has a very high resistivity and can be used for coating the electrical wiring of medium and low voltage, however in case of higher voltage it is necessary to apply several isolating layers, wherein the outer layer should be the last layer counting from the centre of the wire.

The subject of the invention in the embodiment is presented on the drawing, in which

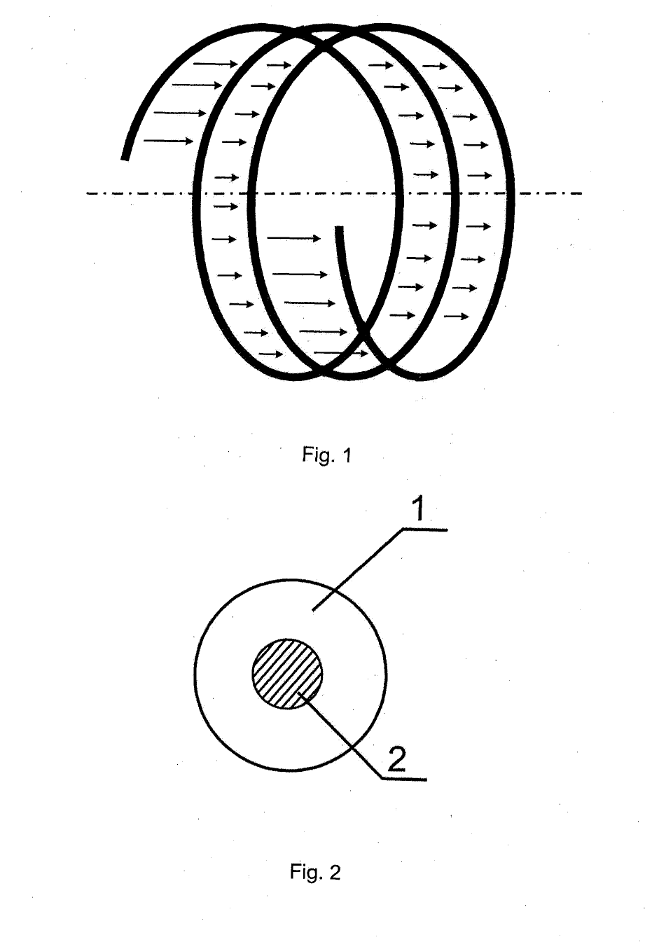

FIG. 1 illustrates the self-rolling elongated element placed in the magnetic field, and

FIG. 2—the power transmission wire made of a wire of a circular cross section with the outer layer of thickness equal to its diameter,

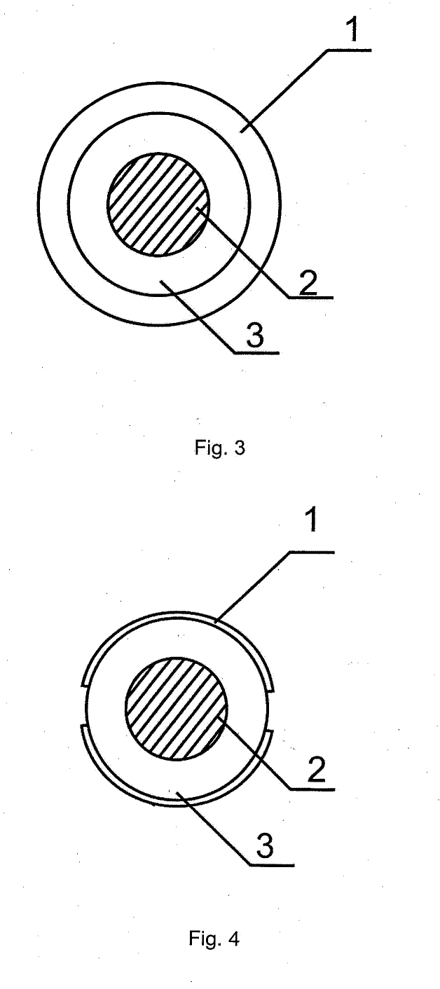

FIG. 3—the power transmission wire made of a wire of a circular cross section with the polymer layer and an outer layer,

FIG. 4—the power transmission wire made of a wire of a circular cross section with the polymer layer and an outer layer applied in the form of two tapes,

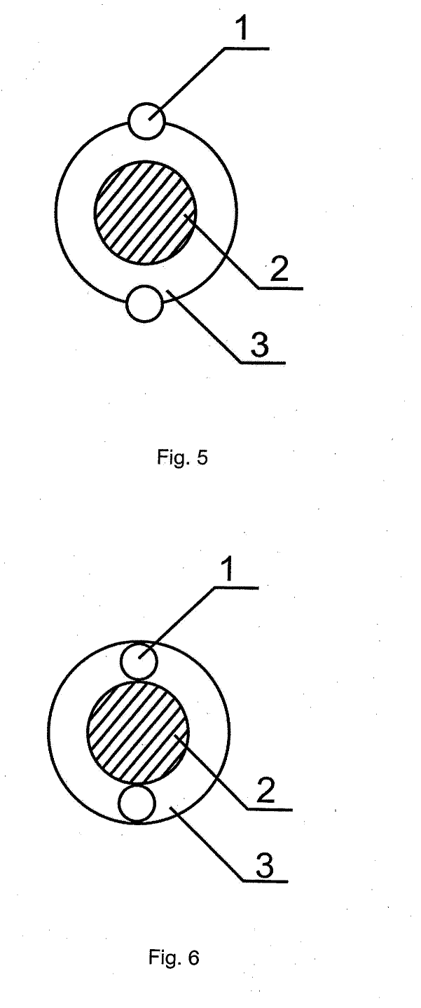

FIG. 5—power transmission wire made of a wire of a circular cross section with bars made of material with magnetic properties placed in the polymer,

FIG. 6—power transmission wire made of a wire of a circular cross section with bars made of material with magnetic properties embedded in the polymer,

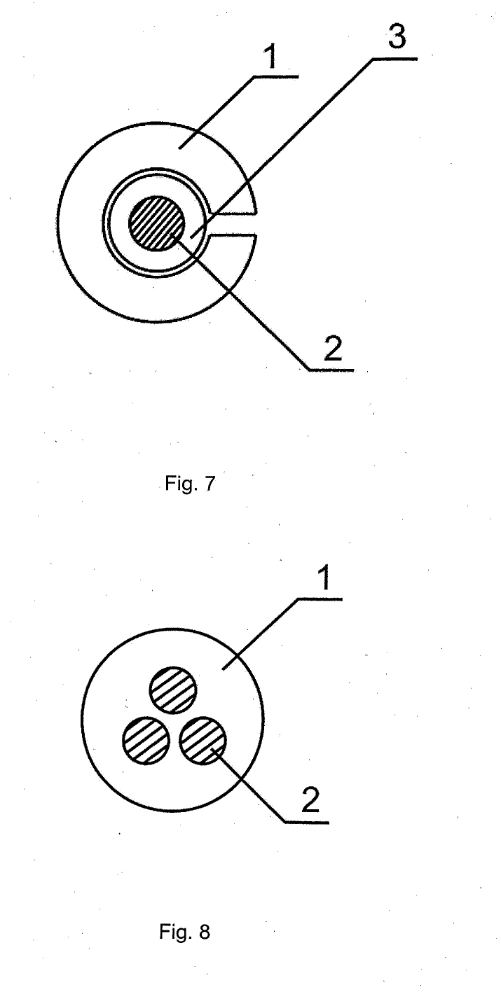

FIG. 7—power transmission wire made of wire of a circular cross section covered with the polymer coating with applied polymer composite made as an independent element,

FIG. 8—the power transmission wire made of three wires of a circular cross section embedded in the outer layer,

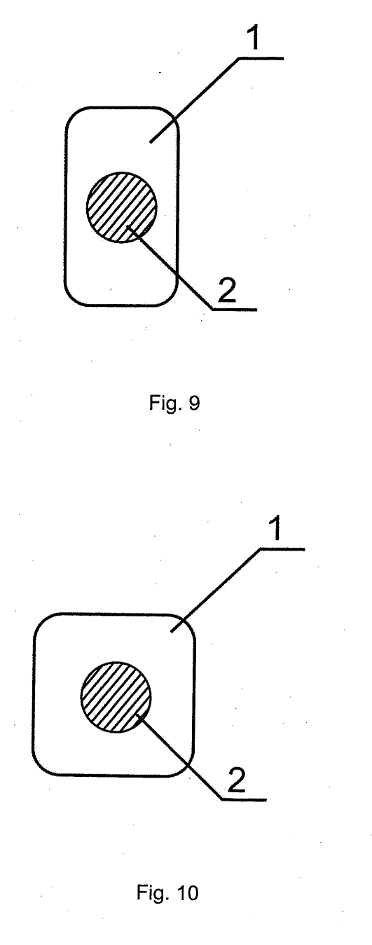

FIG. 9—the power transmission wire made of a wire of a circular cross section embedded in the outer layer of a rectangular cross section,

FIG. 10—the power transmission wire made of a wire of a circular cross section embedded in the outer layer of a square cross section,

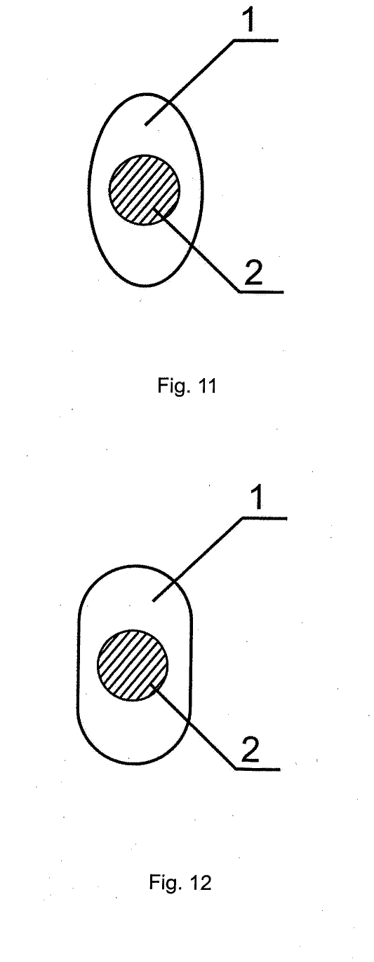

FIG. 11—the power transmission wire made of a wire of a circular cross section embedded in the outer layer of a elliptic cross section,

FIG. 12—the power transmission wire made of a wire of a circular cross section embedded in the outer layer of a oval cross section.

### EXAMPLE 1

The method of production of elongate element, especially an electric cable consists in applying outer layer 1 of the thickness of at least its diameter on the power transmission wire, wherein the outer layer 1 is constituted by a polymer composite consisting of polymer and comminuted material with magnetic properties in the amount of 60% by weight in the form of ferrite. Subsequently, the power transmission wire 2 with the applied outer layer 1 is being magnetized in magnetic field, which lines are situated along the axis of element rolling, wherein the magnetic induction is higher than 2 Tesla.

### EXAMPLE 2

The production method of elongate element, especially the electric cable, proceeds as in the first example, except that the outer layer 1 is applied to the power transmission wire 2 in the magnetic field. Moreover, the outer layer 1 is applied from polymer composite consisting of polyvinylchloride and material with magnetic properties in the amount of from 10%, that is neodymium in the form of bars.

### EXAMPLE 3

The self-rolling elongate element, especially the electric cable, consists of the outer layer contacting directly, with the environment of the cable made of polymer composite, consisting of a polymer and a material with magnetic properties in the amount of 60% by weight-ferrite, wherein the outer coating is magnetized along the axis of the element rolling. Additionally the power transmission wire 2 is made of a wire of a circular cross section, with the outer layer 1 of thickness equal to at least its diameter.

### EXAMPLE 4

Self-rolling elongate element, especially an electric cable, made as in the example one, except that on the power transmission wire 2 made of wire with a circular cross section with the polymer layer 3, outer layer 1 is applied.

### EXAMPLE 5

Self-rolling elongate element, especially an electric cable, made as in the example one, except that on the power transmission wire 2 made of wire with a circular cross section with the polymer layer 3, outer layer 1 in the form of two tapes is applied.

### EXAMPLE 6

Self-rolling elongate element, especially an electric cable, made as in the example one, except that on the power transmission wire 2 made of wire with a circular cross section polyvinylchloride layer 3 is applied, on which bars made of material with magnetic properties in the form of neodymium are placed.

### EXAMPLE 7

Self-rolling elongate element, especially an electric cable, made as in the example one, except that on the power transmission wire 2 made of wire with a circular cross section polymer layer 3 is applied, in which bars made of material with magnetic properties are embedded completely.

### EXAMPLE 8

Self-rolling elongate element, especially an electric cable, made as in the example one, except that on the power transmission wire 2 made of wire with a circular cross section with the polymer layer 3, independent polymer composite is applied.

### EXAMPLE 9

Self-rolling elongate element, especially an electric cable, made as in the example one, except that on the power transmission wire 2 is made of 3 wires with a circular cross section embedded in the outer layer 1.

Self-rolling elongate element can have an outer layer 1 made in any cross section shape, especially the rectangular shape FIG. 9, square shape FIG. 10, elliptical shape FIG. 11, or oval shape FIG. 12. The outer layer 1 can consist of material with magnetic properties made in the form of permanent magnets.

1. The production method of the self-rolling elongate element, especially the electric cable, based on applying to the power transmission wires at least one layer of polymer coating, characterized in applying to the power transmission wire (2) an outer layer (1) from a polymer composite, consisting of a polymer and a material, which has magnetic properties in the amount of from 10% to 60% by weight, and subsequently, the power transmission wire (2) with the applied outer layer (1) is being magnetized in the magnetic fields, which lines are placed along the axis of the element rolling, wherein the magnetic induction is equal to at least 2 Tesla.

2. The method according to claim 1 is characterized in that, to the power transmission wire (2) made of a wire of a circular cross section, the outer layer (1) of thickness equal to at least its diameter is applied.

3. The method according to claim 1 is characterized in that the outer layer (1) is applied to the power transmission wire (2) in the magnetic field.

4. The method according to claim 1 is characterized in that the outer layer (1) is applied directly to the metal power transmission wire (2).

5. The method according to claim 1 is characterized in that the outer layer (1) is applied from the polymer composite consisting of polyvinylchloride.

6. The method, according to claim 1 is characterized in that the outer layer (1) is applied from the polymer composite consisting of ferrite.

7. The method according to claim 1 is characterized in that the outer layer (1) is applied from the polymer composite consisting of neodymium.

8. The self-rolling elongate element, especially the electric cable, consisting of the metal power transmission wire covered with at least one layer of polymer coating, characterized in that the outer layer (1), contacting directly with the environment of the cable made of polymer composite, consisting of a polymer and a material with magnetic properties in the amount of 60% by weight, wherein the outer coating (1) is magnetized along the axis of the element rolling.

9. The element according to claim 8 is characterized in that the outer layer (1) is applied directly to the metal power transmission wire (2).

10. The element according to claim 8 is characterized in that the polymer is polyvinylchloride.

11. The element according to claim 8 is characterized in that the material with magnetic properties is ferrite.

12. The element according to claim 8 is characterized in that the material with magnetic properties is neodymium.

13. The element according to claim 8 is characterized in that, to the power transmission wire (2) made of a wire of a circular cross section, the outer layer (1) of thickness equal to at least its diameter is applied.

14. The element according to claim 8 is characterized in that the material with magnetic properties is comminuted.

15. The element according to claim 8 is characterized in that the material with magnetic properties is made in the form of tapes.

16. The element according to claim 15 is characterized in that the tapes are placed on the polymer layer (3).

17. The element according to claim 15 is characterized in that the tapes are embedded in the polymer layer (3).

18. The element according to claim 8 is characterized in that the material with magnetic properties is made in the form of bars.

19. The element according to claim 18 is characterized in that the bars are placed on the polymer layer (3).

20. The element according to claim 18 is characterized in that the bars are embedded in the polymer layer (3).

21. The element according to claim 8 is characterized in that the material with magnetic properties is made from the permanent magnets.
